(19) United States
(12) Patent Application Publication
(10) Pub. No.: US 2007/0053002 A1
(43) Pub. Date: Mar. 8, 2007

(54) Template and Process to Assist in the Design of Artwork for Image Transfers and their Application onto Tapered Tubular Parts

(75) Inventor: Alex T. Dee, Carlsbad, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Fujikura Composite America, Inc., Vista, CA (US)

(21) Appl. No.: 11/459,210

(22) Filed: Jul. 21, 2006

Related U.S. Application Data
(60) Provisional application No. 60/702,022, filed on Jul. 21, 2005.

(51) Int. Cl. G06K 15/00

(52) U.S. Cl. 358/1.18; 715/517

(57) ABSTRACT

Methods are provided herein for the design of image transfers, such as decals, including artwork to parts, such as tubular parts. In one implementation, a method of generating artwork for application to a part is provided including the steps of: generating a template based at least in part on a movement of a component of a machine that applies image transfers including the artwork to the part; and designing the artwork in accordance with the template, the artwork adapted to be made into an image transfer to be applied to the part. In another implementation, an image transfer to be transferred to a part by a machine, the image transfer comprising: a carrier film; and artwork formed on the carrier film, the artwork created using a template based at least in part on a movement of a component of the machine that will apply the image transfer including the artwork to the part.

This application claims the benefit of U.S. Provisional Application No. 60/702,022, filed Jul. 21, 2005, entitled TEMPLATE AND PROCESS TO ASSIST IN THE DESIGN OF ARTWORK FOR DECALS AND THEIR APPLICATION ONTO TAPERED TUBULAR PARTS, which is incorporated in its entirety herein by reference.

### BACKGROUND OF THE INVENTION

1. Field of the Invention

The present invention relates generally to decals to be applied to parts, and more specifically to the design of decals and application to parts, such as tubular shafts.

2. Discussion of the Related Art

Decals are commonly used in the application of multi-colored graphics onto tapered shafts and other tubular commercial products. Decals are basically inks silk-screened onto a carrier film, and they are transferred to the shaft or part by heat. Therefore, these decals are also commonly referred to as “heat-transfers”. An example of a heat-transfer roll 100 is shown in FIG. 1 having a repeating graphic 102. It is noted that the cross hatching in FIG. 1 is used to indicate a color. ITW (Illinois Tool Works, Inc. of Glenview, Ill.) is a leader in the manufacturing of heat-transfers and the machines that apply the heat-transfers onto tapered and tubular products. ProMark of Manchester, Conn., a company owned by ITW, serves to create or accept provided artwork and uses their expertise to convert artwork to heat-transfers. Also owned by ITW is United Silicon of Lancaster, N.Y., a company that manufactures heat-transfer application machines for tapered and tubular products. A specific type of commercially available heat transfer machine 200 known as the “Ace II” made by United Silicon is shown in FIG. 2.

The appearance of a given commercial product plays an important role in product branding and perceived product quality. Therefore artwork and decals for tapered and other tubular commercial products have evolved from being small, single colored, and one-sided to being large, multi-colored and full-wrapped around the part. This is particularly true in recent years in the branding of tubular products such as golf club shafts. Creating artwork meant to be applied on single or multi-tapered and tubular parts is challenging and currently a trial-and-error process. The difficulty lies in designing decals which when applied onto a product or part will simultaneously align laterally (also referred to as latitudinally) and longitudinally. The lateral direction is defined as along the circumference of the tubular part and the longitudinal direction is defined as along the length of the part. Straight, lateral lines tend not to align at or near the seam when wrapped around the part, shown as latitudinal misalignment 300 and 400 in FIGS. 3 and 4. The seam 402 is defined as the area of the heat transfer where overlapping occurs from the application. It is noted that the different cross hatchings in FIGS. 3 and 4 are used to indicate different colors. Straight, longitudinal artwork on a decal will tend to skew when wrapped around the part, shown as longitudinal misalignment 500 in FIG. 5. In FIG. 5, the tip 502 of the image at the right is longitudinally misaligned relative to the axial center line 504 shown for reference.

Referring to FIG. 6, currently, tubular shaft artwork geometry is primarily derived from the geometry of the specific part. For example, with the diameters of the shaft known along its length, it is possible to determine the minimum widths required for the decal by calculating the circumference (circumference=D*π, where D is the part diameter and π is pi). A closed ring of artwork intended to wrap around the shaft with perfect alignment at the seam is illustrated on a two-dimensional decal as a straight, lateral line, e.g., see lateral artwork line 602 of FIG. 6. For alignment in the longitudinal direction, circumferential distances at the top and bottom of the decal (i.e., C₁ and C₂ of FIG. 6) are commonly divided equally into quadrants, and imaginary lines are drawn between corresponding quadrants (see FIG. 6). If artwork consists of independent, longitudinal art that is required to be exactly 180 degrees apart about the circumference and both aligned in the longitudinal direction (such as longitudinal artwork lines 604 and 606 of FIG. 6), it is assumed that the artwork should be designed with alignment to the lines separated by the half the circumference.

A tedious trial-and-error process then consists of creating an initial sample of the decal, applying the decal to the part, checking for misalignment problems (such as shown in FIGS. 3-5), making corrections to the artwork by rotating and/or translating specific components of the artwork, and repeating as necessary. Thus, the rotated or adjusted artwork is made into a sample decal, then applied again to the part to see if the rotation/translation corrects the misalignment problems. If not corrected sufficiently, the process is further repeated (further adjusting the artwork, creating a further sample decal, applying to the part and inspecting) until the alignment is satisfactory. This back and forth trial-and-error process between the artwork designer (to create the artwork for the decal), the decal maker (to generate sample decals including the artwork) and the person/s applying the decal to the tubular part and inspecting (to verify that the artwork works properly for the given shaft) takes much time and effort and can increase development time and delay product release.

### SUMMARY OF THE INVENTION

Several embodiments of the invention provide methods for the design of image transfers, such as decals, including artwork to parts, such as tubular parts. In one embodiment, the invention can be characterized as a method of generating artwork for application to a part comprising the steps of: generating a template based at least in part on a movement of a component of a machine that applies image transfers including the artwork to the part; and designing the artwork in accordance with the template, the artwork adapted to be made into an image transfer to be applied to the part.

In another embodiment, the invention can be characterized as a method of generating artwork for application to a part comprising the steps of: providing a template based at least in part on a movement of a component of a machine that applies image transfers including the artwork to the part; creating the artwork in accordance with the template, the artwork adapted to be made into an image transfer to be applied to the part.

In a further embodiment, the invention may be characterized as an image transfer to be transferred to a part by a machine, the image transfer comprising: a carrier film; and artwork formed on the carrier film, the artwork created using a template based at least in part on a movement of a component of the machine that will apply the image transfer including the artwork to the part.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a roll of carrier film containing repeating images or graphics that form decals as is traditionally done.

FIG. 2 is a photograph of a conventional machine used for the application of decals to tubular shafts.

FIG. 3 is an illustration of tubular shaft having a decal applied illustrating lateral or latitudinal misalignment of the decal.

FIG. 4 is an illustration of a tubular shaft having a decal applied illustrating lateral or latitudinal misalignment of the decal at the seam or overlapping portion of the decal.

FIG. 5 is an illustration of a tubular shaft having a decal applied illustrating longitudinal misalignment toward the right side of the decal, such as the decal of FIG. 1.

FIG. 6 is an illustration of a conventional decal design process emphasizing shaft diameters at the upper and lower ends of the graphic location on the shaft having a constant taper.

FIG. 7 is a photograph of the machine of FIG. 2 better illustrating various components of the machine.

FIG. 8 is an engineering drawing, including a plan view and a side elevational view of a cam of the machine of FIG. 7.

FIG. 9 is an illustration of the movement of the various components of the machine of FIG. 7 including the derivation of a path of movement of the machine in accordance with one embodiment.

FIG. 10 is a representation of a template and also a corresponding test decal in accordance with several embodiments of the invention.

FIG. 11 is a photograph of the test decal of FIG. 10 as applied to a tubular shaft in accordance with several embodiments of the invention.

FIG. 12 is a flowchart illustrating the steps performed in accordance with several embodiments of the invention.

FIG. 13 is an illustration of artwork made in accordance with the embodiment of the template illustrated in FIG. 10, the artwork to be made into a decal for application to a part.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments.

According to several embodiments of the invention, a template and a process associated with its use is described herein and addresses the complexity of designing properly aligned artwork and assuring its proper application to products or parts having a non-uniform geometry. In accordance with several embodiments, the artwork geometry is derived more as a function of the fixed-movement geometry of the application machine rather than the geometry of the product or part. For example, the artwork is created based at least in part due to the motion of a component of the machine used to application the image transfer including the artwork to the product or part. In many applications, the use of a template, and/or a process according to several embodiments will expedite the development of artwork to be applied to such products, creating shorter lead times and allowing for the creation of complex image transfers (such as heat transfers or decals) once considered impossible or too risky for mass production.

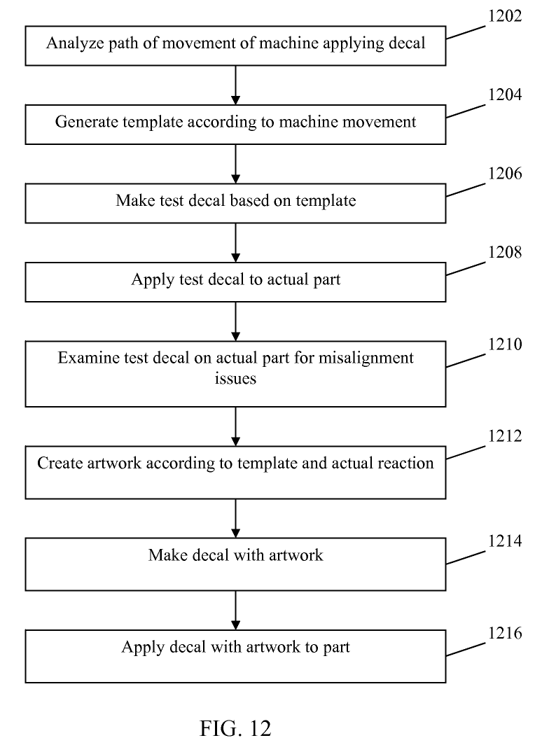

The following description describes several embodiments for use in generating artwork to be applied to tapered and generally tubular parts (such as shafts). Generally, while discussing several figures specifically, concurrent reference is made to FIG. 12, which generally illustrates the steps to generate artwork in accordance with several embodiments of the invention.

According to several embodiments, rather than solely focusing on the geometry of the part (e.g., a tapered tubular shaft), the artwork is generated at least in part by understanding the fixed movement of the part within the application machine that actually applies the decal or heat transfer (generically referred to as an image transfer) including the artwork is a first step in overcoming trial and error process. That is, an initial step is to analyze the movement of the machine that will apply the image transfer (such as a heat transfer or decal) to the part (Step 1202 of FIG. 12). For example, in the context of an application to typical decal application machines and referring to FIG. 7, the shaft 702 (generically referred to as part 702) is pressed while being moved and rotated by a shaft carrier 704 against a silicon heat pad 706 (the decal-film 708 or image transfer film positioned between the part and the heat pad) and rotated along the stationary heat pad, causing the transfer of the decal to the part. FIG. 7 shows a secured shaft 702, the decal film 708, the silicon pad 706, and the shaft carrier 704 as configured prior to application. The shaft carrier 704 holds the part 702 at both ends so that the part moves with the shaft carrier, while allowing for the part to rotate. The movement of the shaft carrier 704 is guided by a cam (not shown in FIG. 7).

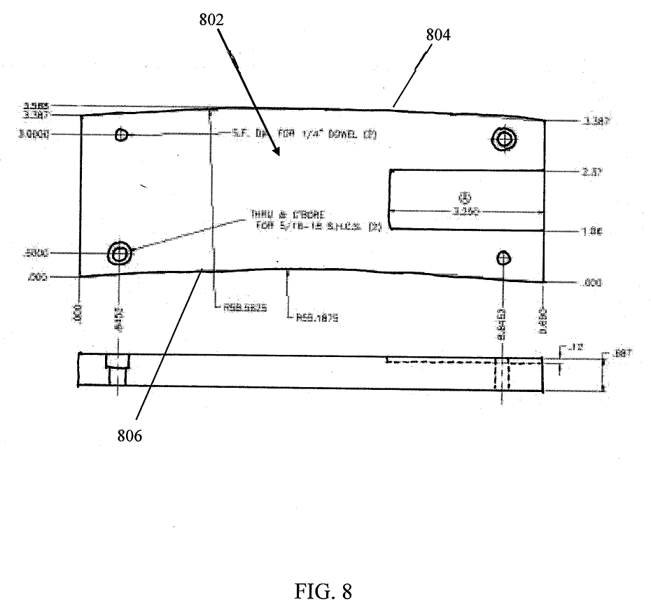

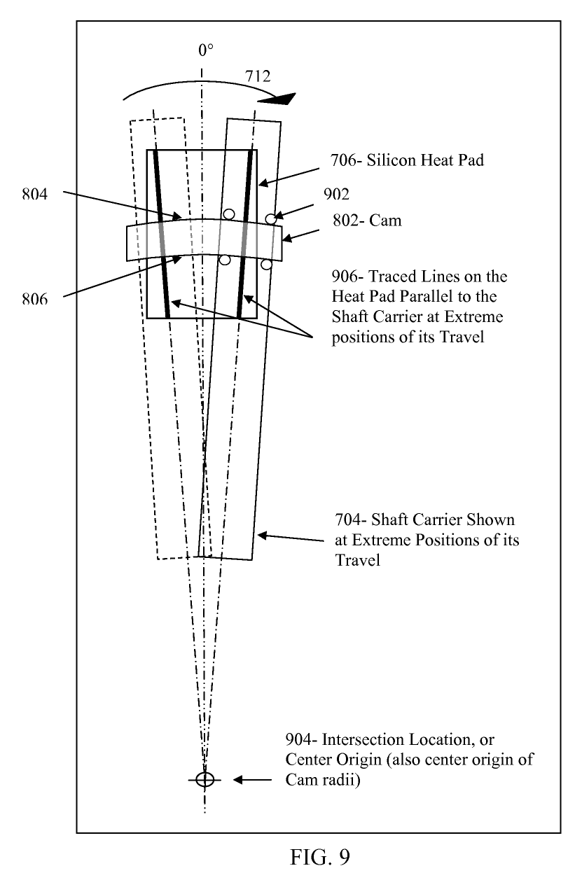

Referring also to FIGS. 8 and 9, knowing that most parts are tubular and tapered, United Silicon designed a fixed cam 802 on the machine that the shaft carrier travels upon. While it is not visible in FIG. 7, the shaft carrier 704 is mounted to wheels 902 (see FIG. 9) that follow the shape of the cam 802 just beneath it. Thus, the shaft carrier 704 moves in the path of motion dictated by the shape of the fixed cam. Any shaft or tubular part, regardless of its specific dimensions or shape is moved by the shaft carrier, and is thus also restrained to move in the motion defined by the fixed cam 802. A plan view and side view of the cam is shown in FIG. 8, and its location in the machine is illustrated in FIG. 9. As can be seen, the shape of the cam (illustrated as arcs or curvatures 804 and 806) causes the shaft carrier to move according to the same arc or curvature. In the view of FIG. 7, the shaft carrier 704 will move from its starting position limited by stopper 710 in the direction of arrow 712 to an ending position at stopper 714. If the part (e.g., tapered tubular shaft) were allowed by the machine to move freely under the heat pad as a function of its geometry, then known solutions for designing artwork should allow for less stretching and deformation of the film carrying the decal as it is applied, but the artwork would then need to be designed in terms of the natural rolling motion of the part, i.e., the part's natural arc of travel. But most parts have taper changes, so this can lead to alignment issues even if the machine were to move in the natural movement of the part. In the illustrated machine, the movement of the shaft is constrained to move according to the design of the cam and shaft carrier, which doesn't match the exact geometry of the tubular part. It is noted that while in several embodiments, the component of the machine has a path of movement that follows an arc, it is understood that other machines may be designed such that the component that moves the part follows a path of movement that is not an arc. The principles of several embodiments may also be applied to create templates based at least in part on a path of movement of the component other than an arc, and thus, to create corresponding artwork and image transfers.

In one embodiment, the motion of the shaft carrier 704 due to the cam is characterized by solving for the center origin (or polar coordinate of 0,0) of the arc defined by the curvatures 804 and 806 (which is also the arc of the movement of the shaft carrier). During the shaft's movement in application, its axial position is always oriented towards the center origin, much as spokes on a wheel all point to the wheel hub. Therefore, in some embodiments, artwork that is to align in the longitudinal direction should correspond to the longitudinal orientation of the shaft during its application. Since the travel of the shaft sweeps an arc, according to several embodiments, any lateral line (generically referred to as a linear structure) required on the part should actually be illustrated as an arc (instead of a line), whose radius is anchored to the center origin. A polar coordinate system for designing image transfer (e.g., decal) artwork is proposed in several embodiments when the application utilizes a machine that dictates the movement of the part to which the image is to be applied, similar to the type of machine described.

Referring to FIG. 9, the center origin 904 of the arc of movement of the shaft carrier (and thus of the shaft or part) should coincide with the radius of the cam. In one embodiment, in order to determine the center origin, a piece of paper was attached to the heat pad 706, and lines 906 were traced on the paper parallel to the shaft carrier at both extremes of its travel (e.g., at stoppers 710 and 714). These lines were extended to determine where they intersect, the intersection point defining the center origin of the arc of movement. For example, a computer-aided drafting (CAD) program was used to determine the intersection of these two lines. The intersection location of these lines is the center origin of the arc travel and also coincides with the center origin of the cam radius. FIG. 9 is an illustration showing how the center origin was derived as well as the relationship between the fixed cam 802 and the shaft carrier 704 and the travel arc (shown as arrow 712).

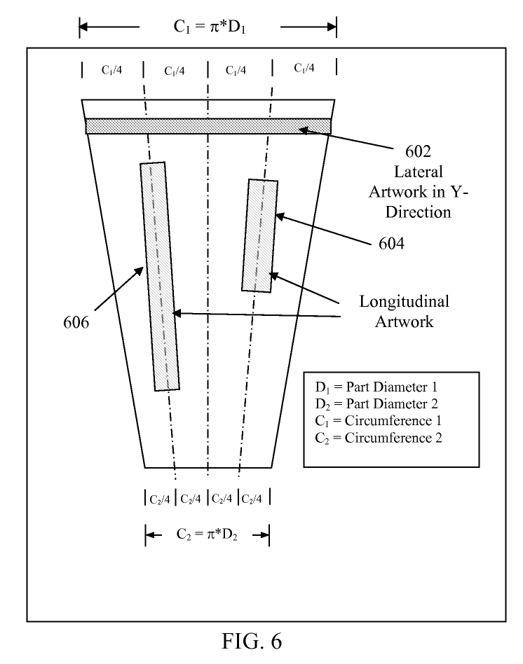

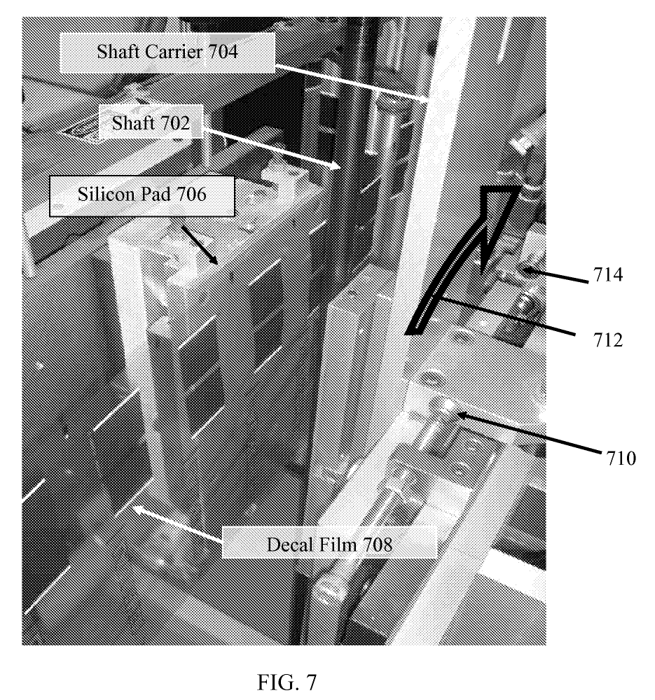

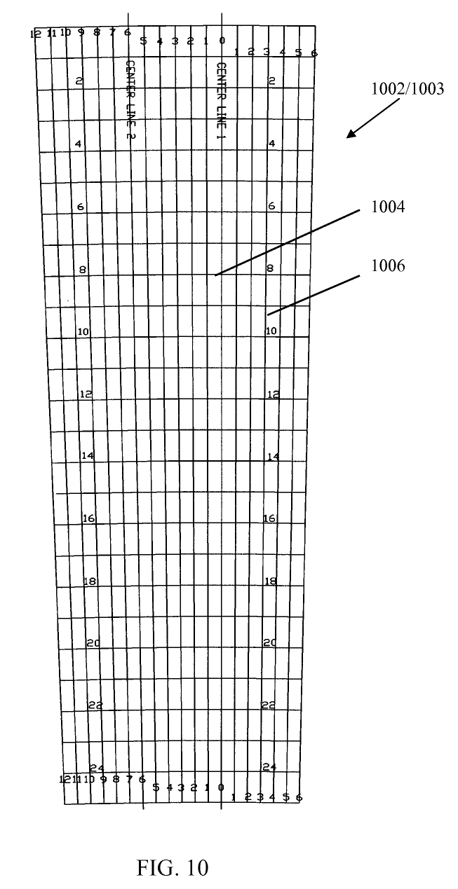

Once the movement of the relevant portions of the application machine are analyzed and understood (Step 1202 of FIG. 12), next, a template is generated that is derived based on the movement of the application machine (Step 1204 of FIG. 12). In several embodiments, the template has lines based at least in part on a movement of a component of the machine that will be used to apply image transfers to the shaft. For example, in the context of the machine analyzed in the example above and referring to FIG. 10, based on the determined arc of movement and center origin of the travel path of the machine component that moves the shaft 702 during application, a template 1002 was designed (e.g., using a software tool, such as AutoCAD or Adobe Illustrator). In preferred form, artwork (from which decals will be made) will be created in accordance with the template, as opposed to the traditional approach shown in FIG. 6. In one embodiment, the template 1002 includes several linear arcs 1004 (e.g., labeled as arcs 0-25) in the lateral direction and several lines 1006 (e.g., labeled as lines 1-12 to the left of the 0 degree line and lines 1-6 to the right of the 0 degree line) in the longitudinal direction, as shown in FIG. 10. It is noted that generally, the arcs 1004 and the lines 1006 may be referred to as lines. All arcs are of different radii originating from the center location 904 and the radii correspond to distances that overlap the location of the heat pad. All longitudinal lines, if extended, would intersect at the center location 904. In preferred form, the scaling of the template 1002 is such that each longitudinal line is uniformly spaced apart and that in the application of golf club shafts, a distance of about 12 longitudinal lines is a full wrap of the shaft. In one form, the template 1002 is a grid or layer that may be implemented in an image manipulation software product, such that artwork can be generated to conform with or to be proportional to the template, that is, the artwork can be distorted (stretched, shortened) to fit the arcs of the template (e.g., straight lines, like line 602, is stretched into an arc). According to preferred embodiments, artwork to be created for decals for application to tubular parts is designed according to the template 1002, which was created at least in part according to the movement of the machine that applies the decal to the part.

Next, a test decal (generically referred to as a test image transfer) is made according to the template (Step 1206 of FIG. 12). For example, the lines of the template 1002 are used as the artwork of the test decal 1003. The test decal 1003 is also shown in FIG. 10 as being the same as the template 1002; however, the template 1002 is the image or layer, while the test decal 1003 is a physical decal on a carrier film made using the template lines as the artwork. As is typically done, in order to make the test decal, the template is delivered as artwork to a decal maker (e.g., a company such as Promark).

Once the test decal is received from the decal maker, the next step is to apply the test decal 1003 with the lines to the actual shaft or part that artwork is to be designed for (Step 1208 of FIG. 12) at the required artwork location. There are several ways to apply the test decal (Step 1208) that will give variously results according to different embodiments, including:
1) A full-wrap image transfer (e.g., decal) where the artwork will include a 0 degree longitudinal line (for example, shown as CENTER LINE 1 in FIG. 10) and all other longitudinal lines thereafter fanning out to one side away from the 0 degree longitudinal line orientation. Using the test decal for this case, CENTER LINE 1, the 0 degree longitudinal line, is applied to the shaft first, and subsequent longitudinal lines to the left of CENTER LINE 1 up to line 12 are applied as necessary to fully wrap the part. In this version, the shaft is fully wrapped at line 12. Misalignments using this approach will become more apparent for longitudinal lines farthest from the starting point (e.g., at lines 11 and 12).
2) A full-wrap image transfer (e.g., decal) where the artwork will include a 0 degree longitudinal line at the center of the artwork, and the fanning of the other longitudinal lines are to the left and right of the 0 degree longitudinal line. In this case, the test decal is applied first at longitudinal line 6 to the right of the 0 degree line. CENTER LINE 1, the 0 degree longitudinal line, is applied at the center of the shaft travel, and subsequent longitudinal lines left of CENTER LINE 1 are applied as necessary to fully wrap the part. In this version, the shaft is fully wrapped at the longitudinal line 6 to the left of the 0 degree line.
3) A partial wrap (less than a full wrap) image transfer following either (1) or (2) above. For example, either longitudinal lines align at the starting edge of the decal (like (1) above) or start at a point beyond the starting edge of the decal (like (2) above). In either case, the portion of the test decal 1003 applied to the shaft is less than that needed to fully wrap the shaft. It is noted that lateral misalignment is not as important with a partial wrap; however, longitudinal misalignment can be problematic.

Once the test decal 1003 is applied to the specific part, the part is checked for any remaining lateral or longitudinal misalignments that might require correction (Step 1210 of FIG. 12). Generally, if the part has a uniform taper throughout the portion to which the test decal is applied, all lateral lines 1004 (arcs) of the test decal should substantially align at the seam and all longitudinal lines (1006) should all be aligned centrally within the shaft and point toward the center location (i.e., there will be no lateral or longitudinal misalignments). However, in some parts, there are taper changes in the portion of the shaft that artwork is to be designed for, i.e., some parts have a non-uniform taper along their length.

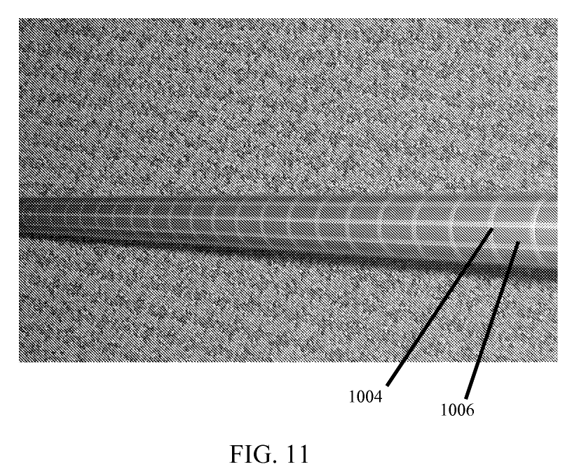

In one embodiment, the photograph of FIG. 11 illustrates a tubular part having a substantially uniform taper with the test decal applied thereto as a full wrap (according to (1) or (2)). All lateral lines 1004 and longitudinal lines 1006 are aligned at the seam. In various tests with shafts of differing geometries, all lateral lines completely aligned at the seam of the test decal 1003 (see FIG. 11). These results prove that using straight, lateral lines (such as shown in FIG. 6) instead of arcs in artwork (like arcs 1004 in the test decal 1003) to form rings around the shaft will result in unforeseen errors and challenges to correcting the problem when applied with a machine that moves the part in an arc.

However, it is understood that different parts may have different tapers. For example, one golf club shaft may be specifically designed to have multiple taper points over the portion that a decal will cover, while another does not. That is, the shaft has at least one or more taper sections. Such varying tapering results in stretching of the carrier film, which can distort or skew the artwork as applied to the shaft. However, with regard to lateral misalignment, it has been found that small changes in taper over the graphic portion of the shaft do not result in lateral misalignment problems. Thus, lateral misalignment problems using the test decal 1003 usually only occur if there are large taper changes. More commonly, such taper changes can result in longitudinal misalignment or skewing. Predicting the skew of longitudinal lines is challenging, but by applying the test decal 1003 on the specific part for which artwork is to be designed for, longitudinal skewing associated with the specific part as a function of radial orientation can be measured prior to generating the artwork for the specific shaft.

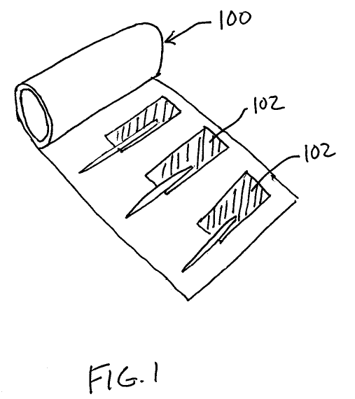

Once these misalignment problems are known for a specific part, the actual artwork to be applied to the specific part can be created using the template 1002 and further corrected by seeing how the test decal 1003 reacts to the actual part, such that the first time a decal is made with the actual artwork (like the artwork of FIG. 1) and applied to the shaft, it is laterally and longitudinally aligned without the traditional trial-and-error process. For example, after applying the test decal 1003 to a given shaft using approach (1) described above, it is determined that lines 12-11 are longitudinally misaligned by 2.5 mm, while line 10 is longitudinally misaligned by 2 mm and lateral lines 16-20 are laterally misaligned 1 mm. This assumes a severe change in taper near lateral lines 16-20. Accordingly, the artwork is generated such that any lateral and longitudinal linear structures (lines, color bands, text strings, images, etc.) are aligned with the grid structure of template 1002, and these linear structures occurring at the portions of the decal corresponding to longitudinal lines 10-12 and lateral lines 16-20 are further corrected.

Thus, the artwork to be applied to the specific part is made to conform to the arcs and lines of the template 1002 with further corrections applied to these arcs and lines based on the interaction of the test decal as applied to the specific part, i.e., the artwork is designed or created according to the template and the actual reaction of the test decal to the part (Step 1212 of FIG. 12). It is understood that artwork may be any arrangement of color, lines, and/or images. The artwork may be as simple as a single band or stripe of color, or a complex image with multiple bands of color and text or graphic images. There are several different ways to design or generate artwork in accordance with this step. For example, in one embodiment, the artwork is provided as a two dimensional image with straight lines, preferably in electronic, editable form. That is, the artwork is not originally designed taking into account any curvature lines. Next, using well known image processing software programs, such as AutoCAD (commercially available from Autodesk, Inc.) or Adobe Illustrator (commercially available from Adobe Systems Incorporated), the template 1003 is added as a layer to the two dimensional image, and the image is made to conform to the radial grid structure of the template layer. In effect, this distorts the two-dimensional image such that the image and all of its linear structures or features align to the template. Further distortions are applied to the portions of the image that correspond to portions of the test decal that were misaligned when the test decal was actually applied to the part. In another embodiment, the artwork is generated from the ground-up using the template 1002 as a guide such that the image and all of its linear structures conform to the arcs and radial lines of the template 1002. Additional distortions are also applied to the portions of the image that correspond to portions of the test decal that were misaligned when the test decal was actually applied to the part. In the example above, the image once conformed to the template is further corrected such that any linear lateral structures near lateral lines 16-20 are corrected 1 mm, and any linear longitudinal structures at lines 10-12 are corrected either 2.5 mm or 2 mm, such that all of these linear structures will be aligned once implemented on as decal and wrapped around the part. In one embodiment, this correction can be done using an image manipulation software product.

Once the artwork is made that is specific to the part per Step 1212, the artwork is made into a decal or image transfer (Step 1214 of FIG. 12). That is, the artwork is formed on a carrier film to create an image transfer or decal. Note that there are no template lines on this decal, only the artwork intended to be applied to the shaft. At this point, the decal including the artwork is applied to the specific shaft using the application machine (Step 1216 of FIG. 12). When applied, there is negligible lateral and longitudinal misalignments without the trial-and-error process of the traditional approach. Advantageously, the template 1002 and test decal 1003 are generated once for a given machine, then artwork can be made for any number of different parts (having differing tapers) that will use that machine for its application. This artwork should laterally and longitudinally align the first time without further trial and error adjustment.

Again, since a shaft is forced to move in a fixed arc rotating about the center origin during the decal application by the machine, in preferred form, the decal artwork should also follow the same arc if it is to be applied properly without misalignments. Previously, more attention was erroneously paid to the geometry of the part when designing the artwork (see FIG. 6). It has been verified that the test decal 1003 is capable of aligning lateral arcs at the seam for several shafts of varying geometry, even without having to apply additional corrections (such as in Steps 1210 and 1212). Thus, in several embodiments, the use of arcs for lateral direction artwork effectively solves the problem of aligning a ring or rings of artwork around the part.

In some embodiments, the next challenge is to assure longitudinal alignment. To achieve this, in preferred form, longitudinal lines in the artwork should be illustrated so that all longitudinal lines intersect at the derived center origin of the arc travel, not in accordance with divisions between upper and lower dimensions of the shaft, such as shown in FIG. 6. It has been demonstrated that if the taper of the part is constant under the graphic area, the longitudinal lines from the test decal 1003 are aligned perfectly along the axis of the shaft (see FIG. 11). Previously, longitudinal alignment was not linked to machine movement but instead solely to shaft geometry.

Several of the embodiments described herein tie together both the artwork creation and the decal application set-up for the first time. For example, if a 0 degree longitudinal line on the decal is to be applied first, the part should also be aligned to the 0 degree longitudinal line before the application. If a 0 degree longitudinal line is to be applied in the center of the travel, the part should be aligned to the 0 degree longitudinal line at the center of its travel.

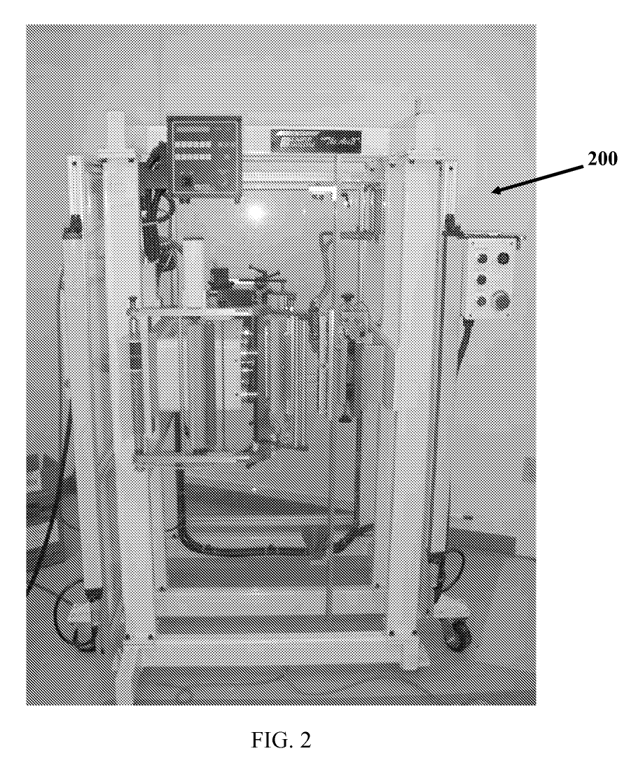

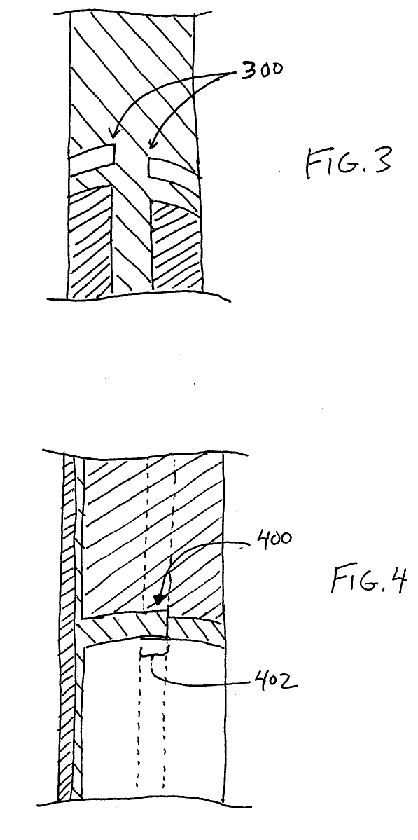

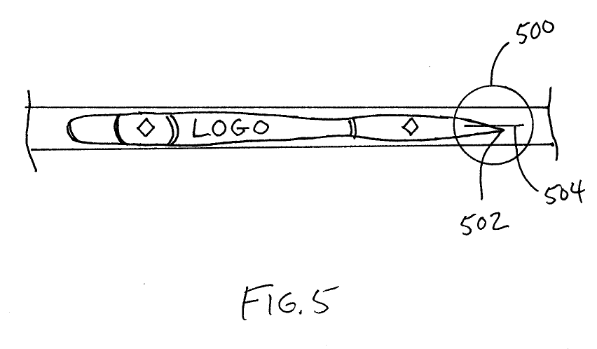

Depending on the artwork and constraints such as the location of the graphic seam (on a full-wrap decal), the decal layout may be designed according to one of the three above types or other types. In the specific case of the machine of FIGS. 2 and 7, the machine is set up so that latitudinal arcs are properly applied as a priority over longitudinal lines. By applying the test decal 1003 based on the template 1002 to the specific part requiring the decal, it is possible to visually determine the skewing of longitudinal lines as they are applied around the shaft for these application methods (Step 1210) and correct for them when designing the actual artwork (Step 1212). There may be instances where the test decal lateral arcs that form rings around the circumference of the shaft do not match up perfectly, hence, in preferred form, Steps 1208, 1210 and 1212 are performed. This is caused by both significant taper changes and stretching of the carrier film during application. Regardless, using the test decal 1003 on the specific part, it is possible to visually determine misalignment of the arcs at the seam and correct for them when designing the actual artwork (Step 1212).

It is noted that in some embodiments, once Steps 1202, 1204 and 1206 are performed, Steps 1208 and 1210 are not performed. Instead, Step 1212 simply becomes to design, create or generate the artwork in accordance with the template 1002. In many instances, the resulting decal should be sufficiently aligned, particularly, if the taper is uniform throughout the portion of the part to which the decal is to be applied, such as illustrated in FIG. 11. In any event, such result is far better aligned than artwork generated using the traditional approach of FIG. 6 without any trial and error. In some embodiments, it is understood that the template may be generated once for a particular machine and shaft, and decals can be designed based on that template. That is, the decal designer is simply provided a template or obtains a template as described above, and then uses this template in the designing, creation or generation of artwork, that will then be sent to a decal maker to make the decal including the artwork.

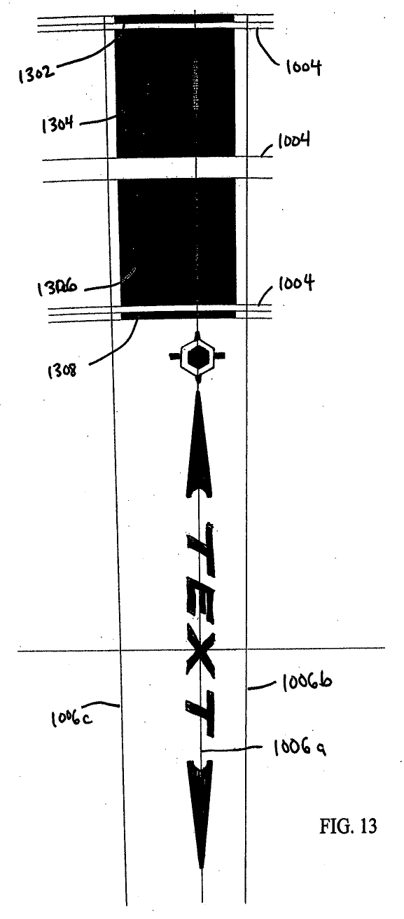

Referring next to FIG. 13, sample artwork made in accordance with the embodiment of the template illustrated in FIG. 10 is illustrated. According to several embodiments of the invention, this artwork will now be provided to a decal maker to create decals including the artwork. Several of the lateral lines 1004 (arcs) and longitudinal lines 1006 (e.g., 1006a, 1006b, 1006c) of the template 1002 are illustrated for reference although they are not part of the actual artwork. The artwork includes several bands of color 1302, 1304, 1306, and 1308, as well as text and other graphics extending generally along the 0 degree longitudinal line 1006a. It is noted that the boundaries of the bands 1302, 1304, 1306, 1308 (generally, linear structures) conform to the arcs and longitudinal lines of the template (i.e., they are actually curved linear structures whose curvature tracks the lines of the template); however, not all of the text and other graphics necessarily conform to the arcs. In this example, the lateral extending portions of the text are not long enough laterally for a user to view any distortion when wrapped. In other embodiments, all of the lateral components of the artwork are drawn to conform to the arcs of the template, like the bands. Once the decal is made, the decal should apply to the particular part with all linear structures having complete lateral and longitudinal alignment at the seam and without the traditional trial-and-error process associated with known processes. Furthermore, it is noted that once this artwork is made into a decal, that the decal will be applied according to method (2) above in which the decal is first applied to the right of the 0 degree line 1006a, although it is noted that the left line 1006c and right line 1006b in FIG. 13 do not necessarily correspond to any particularly numbers longitudinal lines in the template of FIG. 10. It is also noted that generally, a decal maker will produce a roll of decals (such as the roll 100 of FIG. 1) that contains repeating images of the artwork on the carrier film.

In one embodiment, the invention may be characterized as a method of generating artwork for application to a part comprising the steps: generating a template based on a movement of a component of a machine that applies image transfers including the artwork to the part, the template including lateral and longitudinal lines that correspond to the movement of the component; and making the artwork in accordance with the template. In a further variation, the method includes the steps: making a test image transfer of the template; applying the test image transfer to the part using the machine; examining the part for misalignment of the test image transfer to the part; wherein the making the artwork step comprises: making the artwork in accordance with the template and further correcting the artwork based on the misalignment. In preferred form, the part is a tubular part having a substantially circular cross section and at least one taper section; however, it is understood that these principles apply to tubular parts having elliptical or non-uniform cross sections and/or no taper sections, and also applies to non-tubular components (i.e., parts having non-uniform or non-conforming surfaces relative to a two-dimensional image transfer to be applied to the part).

While the invention herein disclosed has been described by means of specific embodiments, examples and applications thereof, numerous modifications and variations could be made thereto by those skilled in the art.

What is claimed is:

1. A method of generating artwork for application to a part comprising:
generating a template based at least in part on a movement of a component of a machine that applies image transfers including the artwork to the part; and
designing the artwork in accordance with the template, the artwork adapted to be made into an image transfer to be applied to the part.

2. The method of claim 1 wherein the template includes lines that correspond to the movement of the component.

3. The method of claim 1 wherein the template includes latitudinal and longitudinal lines that correspond to the movement of the component.

4. The method of claim 1 wherein the part is a tubular part having a substantially circular cross section and at least one taper section.

5. The method of claim 1 wherein the generating step comprises:
generating the template based at least in part on an arc-like movement of a cam of the machine that applies the image transfers including the artwork to the part.

6. The method of claim 1 further comprising:
making the image transfer having the artwork; and
applying the image transfer to the part.

7. The method of claim 1 further comprising:
making a test image transfer of the template;
applying the test image transfer to the part using the machine; and
examining the part for misalignment of the test image transfer to the part.

8. The method of claim 7 wherein the making the artwork step comprises:
designing the artwork in accordance with the template and further correcting the artwork based on the misalignment.

9. The method of claim 1 further comprising:
analyzing a path of movement of the component in order to generate the template.

10. The method of claim 1 wherein the component has a path of movement traveling in an arc, the method further comprising:
determining a center of origin of the arc of the path of movement of the component.

11. The method of claim 1 wherein the designing the artwork comprises designing the artwork with at least a portion conforming to the template, such that at least a portion of the artwork is distorted according to the template.

12. The method of claim 1 wherein the creating the artwork comprises;
designing the artwork; and
distorting the artwork according to the template.

13. The method of claim 12 wherein the distorting step comprises distorting the artwork using an image manipulation software program.

14. The method of claim 1 wherein the making the artwork step includes creating a linear structure in the artwork, the linear structure conforming to the template, wherein when the artwork is made into the image transfer and applied to the part, the linear structure is substantially latitudinally and longitudinally aligned.

15. A method of generating artwork for application to a part comprising:
providing a template based at least in part on a movement of a component of a machine that applies image transfers including the artwork to the part;
creating the artwork in accordance with the template, the artwork adapted to be made into an image transfer to be applied to the part.

16. The method of claim 15 wherein the template includes lines that correspond to the movement of the component.

17. The method of claim 15 wherein the template includes latitudinal and longitudinal lines that correspond to the movement of the component.

18. The method of claim 15 wherein the part is a tubular part having a substantially circular cross section and at least one taper section.

19. The method of claim 15 wherein the creating the artwork comprises creating the artwork with at least a portion conforming to the template, such that at least a portion of the artwork is distorted according to the template.

20. The method of claim 15 wherein the creating the artwork comprises:
designing the artwork; and
distorting the artwork according to the template.

21. The method of claim 20 wherein the distorting step comprises distorting the artwork using an image manipulation software program.

22. The method of claim 15 wherein the template accounts for misalignments due to the path of movement of the component of the machine and additional misalignments from the application of the template to the part.

23. An image transfer to be transferred to a part by a machine, the image transfer comprising:
a carrier film; and
artwork formed on the carrier film, the artwork created using a template including lines based at least in part on a movement of a component of the machine that will apply the image transfer including the artwork to the part.

24. The image transfer of claim 23 wherein the artwork is created using the template, the template including lines that correspond to the movement of the component.

25. The image transfer of claim 23 wherein the artwork is created using the template, the template including latitudinal and longitudinal lines that correspond to the movement of the component.

26. The image transfer of claim 23 wherein the part is a tubular part having a substantially circular cross section and at least one taper section.

27. The image transfer of claim 23 wherein the artwork includes a linear structure conformed to the template, wherein the linear structure is adapted to be substantially latitudinally and longitudinally aligned when the image transfer is transferred to the part.
